(19) United States
(12) Patent Application Publication
(10) Pub. No.: US 2026/0289347 A1
(43) Pub. Date: Sep. 24, 2026

(54) TRAINING DEVICE, TRAINING METHOD, AND RECORDING MEDIUM

(71) Applicant: NEC Corporation, Tokyo (JP)

(72) Inventor: Chenhui HUANG, Tokyo (JP)

(73) Assignee: NEC Corporation, Tokyo (JP)

(21) Appl. No.: 19/562,979

(22) Filed: Mar. 11, 2026

(30) Foreign Application Priority Data
Mar. 24, 2025 (JP) 2025-048087

(51) Int. Cl. G06N 5/04

(52) U.S. Cl. CPC G06N 5/04

(57) ABSTRACT

In the training device, the acquisition unit acquires the explanatory variable and the time difference between the acquisition time point of the true value of the response variable and the current time point. The estimation unit calculates an estimated value of the response variable from the explanatory variable using the estimation model. The difference calculation unit calculates the difference between a true value of the response variable and the estimated value. The loss calculation unit calculates a loss based on the difference and the time difference. The training unit trains the estimation model based on the loss. By using the model trained by the training device to estimate disease risk, it is possible to support decision-making regarding the subject's lifestyle habits.

### INCORPORATION BY REFERENCE

This application is based upon and claims the benefit of priority from Japanese Patent Application 2025-048087, filed on Mar. 24, 2025, the disclosure of which is incorporated herein in its entirety by reference.

### TECHNICAL FIELD

The present disclosure relates to a loss function for use in training of a machine learning model.

### BACKGROUND ART

In general, regarding training of a machine learning model, training is performed in such a way as to minimize a loss calculated based on both a prediction value or estimated value output from the model based on an input value and a true value (ground truth). For example, JP 2001-272994A describes a training device that performs training in such a way as to minimize a loss between a class output from a model and a correct answer.

### SUMMARY

In a case of training a model that performs prediction using data collected in time series, training of the prediction model is performed using training data collected at different time points. In general, the loss function used for training the model is designed to reduce the sum of the differences between the estimated values and the true values, and the loss is calculated by evaluating the training data obtained at every time point with the same importance. In practice, accuracy requirements for short-term prediction are high, but long-term prediction naturally has a large margin of prediction due to unknown factors, and a decrease in prediction accuracy is relatively easily accepted. As described above, in a case where the training of the model is performed using the training data at different time points, it may not be appropriate to evaluate the training data at all time points with the same importance or weight.

One object of the present disclosure is to provide a training device capable of calculating a loss with an appropriate weight according to time an attribute of training data and training a model.

According to an example aspect of the present invention, there is provided a training device comprising:
an acquisition means configured to acquire an explanatory variable and a time difference between an acquisition time point of a true value of a response variable and a current time point;
an estimation means configured to calculate an estimated value of a response variable from the explanatory variable by using an estimation model;
a difference calculation means configured to calculate a difference between the true value of the response variable and the estimated value;
a loss calculation means configured to calculate a loss based on the difference and the time difference; and
a training means configured to train the estimation model based on the loss.

According to another example aspect of the present invention, there is provided a training method executed by a computer, comprising:
acquiring an explanatory variable and a time difference between an acquisition time point of a true value of a response variable and a current time point;
calculating an estimated value of a response variable from the explanatory variable by using an estimation model;
calculating a difference between the true value of the response variable and the estimated value;
calculating a loss based on the difference and the time difference; and
training the estimation model based on the loss.

According to still another example aspect of the present invention, there is provided a program for causing a computer to perform processing comprising:
acquiring an explanatory variable and a time difference between an acquisition time point of a true value of a response variable and a current time point;
calculating an estimated value of a response variable from the explanatory variable by using an estimation model;
calculating a difference between the true value of the response variable and the estimated value;
calculating a loss based on the difference and the time difference; and
training the estimation model based on the loss.

According to the present disclosure, it is possible to calculate a loss with an appropriate weight according to a time attribute of training data and train a model.

### BRIEF DESCRIPTION OF THE DRAWINGS

FIGS. 1A to 1C illustrate exemplary loss functions;

FIGS. 2A and 2B illustrate other exemplary loss functions;

FIGS. 3A and 3B illustrate other exemplary loss functions;

FIG. 4 illustrates other exemplary loss functions;

FIG. 5 illustrates an entire configuration of a training device according to the present disclosure;

FIG. 6 is a block diagram illustrating a hardware configuration of the training device;

FIG. 7 is a block diagram illustrating a functional configuration of the training device;

FIG. 8 is a flowchart of training processing;

FIG. 9 illustrates exemplary loss functions;

FIG. 10 illustrates an exemplary probability distribution of training data;

FIG. 11 is a diagram illustrating hyperparameters in a loss function;

FIG. 12 is a block diagram illustrating a functional configuration of another training device according to the present disclosure;

FIG. 13 is a flowchart of another training processing;

FIG. 14 illustrates an application example of the training device;

FIG. 15 is a block diagram illustrating a configuration of another training device according to the present disclosure; and

FIG. 16 is a flowchart of processing in another training processing.

### EXAMPLE EMBODIMENTS

Hereinafter, preferred example embodiments of the present disclosure will be described with reference to the drawings. In the following description, for convenience of notation, a symbol given above a certain variable is represented by a character next to the variable. For example, a variable “y” with a symbol “Λ(hat)” is written as “y\hat{ }”.

### DESCRIPTION OF BACKGROUND

Using medical examination data tracked on a time-series basis (hereinafter, referred to as “medical examination data”), a value of medical examination data in the future can be predicted, leading to early detection of any anomaly in health. Tracking of the medical examination data is not single, and aged tracking is common. Therefore, in a case of training a model for predicting the risk of a disease or a lifestyle disease based on medical examination data collected periodically every year, training of the model is performed using training data at different time points such as medical examination data for the past several years. In this manner, by using the time-series medical examination data as training data, it is possible to create a model for predicting the health risk at arbitrary future time point in a short or long term from the current medical examination data. The present disclosure trains a prediction model by using a loss function that evaluates training data at different time points with a weight related to a time attribute. As a result, it is possible to calculate a loss with an appropriate weight according to a time attribute of training data and train a model.

### FIRST EXAMPLE EMBODIMENT

### Basic Method

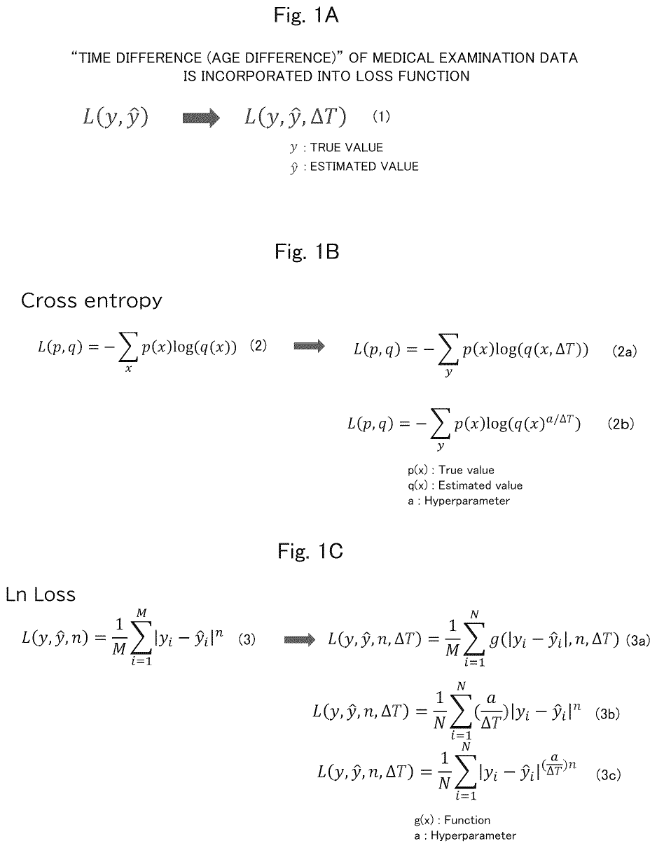

First, a basic method of the present disclosure will be described. In the present disclosure, a loss function considering a time attribute of training data is used in training of a machine learning model. FIG. 1A illustrates a concept of a basic method of the present disclosure. For example, as described above, when training a model that predicts a risk of a disease or the like from the time-series medical examination data, a time difference (an age difference) between the medical examination data is incorporated into the loss function. As illustrated in FIG. 1A, the existing loss function L(y,y\hat{ }) includes a true value y and an estimated value y\hat{ } as variables. On the other hand, as illustrated in Expression (1), a loss function L(y,y\hat{ }, ΔT) of the present disclosure includes a time difference ΔT in addition to the true value y and the estimated value y\hat{ } as variables. The time difference ΔT is incorporated as a weight in the loss function.

### Exemplary Loss Functions

Next, a specific example of the loss function to which the basic method is applied will be described.

### (1) Cross Entropy

FIG. 1B illustrates a cross entropy expression. Expression (2) is an ordinary expression of cross entropy, and Expression (2a) is an expression incorporating the time difference ΔT. In Expression (2a), the time difference ΔT is incorporated as an argument of a function q. Specifically, “a/ΔT” (hereinafter, it is also referred to as a “time adjustment term”) as in Expression (2b) can be incorporated as an index to power a function q(x). As a result, a time adjustment term (a/ΔT) functions as a weight for the function q(x). The time adjustment term (a/ΔT) decreases as the time difference ΔT increases. Therefore, the larger the time difference ΔT, the lower the contribution to the loss. That is, data with a larger time difference ΔT is considered less important in the loss calculation.

### (2) Ln Loss (L1 Loss and L2 Loss)

FIG. 1C illustrates an expression of Ln loss. L1 loss indicates a mean absolute error, and L2 loss indicates a mean squared error. Expression (3) is a general Ln loss expression, and Expression (3a) is an expression incorporating the time difference ΔT. The time difference ΔT is incorporated as a weight for the difference between the true value y and the estimated value y\hat{ }. Specifically, the time adjustment term (a/ΔT) can be incorporated as a coefficient for a difference between the true value y and the estimated value y\hat{ } as in Expression (3b). In addition, as in Expression (3c), the time adjustment term (a/ΔT) can be incorporated into the exponential part of the difference between the true value y and the estimated value y\hat{ }. Any one of Expressions (3b) and (3c) may be used. The time adjustment term (a/ΔT) decreases as the time difference ΔT increases. Therefore, data with a larger time difference ΔT is considered less important in the loss calculation.

### (3) Huber Loss

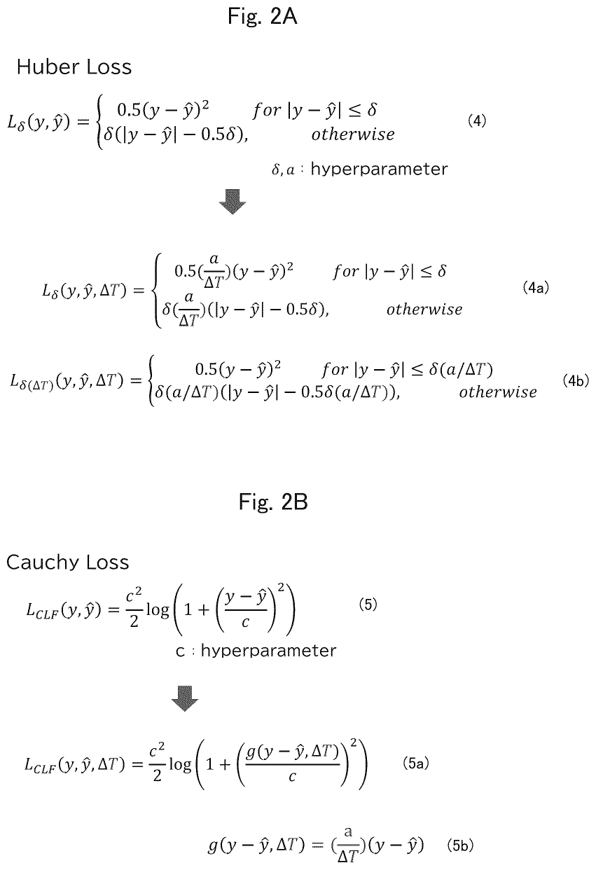

FIG. 2A illustrates a Huber loss expression. The Huber loss has the advantage of mean squared error (MSE) and the advantage of mean absolute error (MAE) in combination. Expression (4) is a normal Huber loss expression, and Expressions (4a) and (4b) are expressions incorporating the time difference ΔT. The time difference ΔT is incorporated as a weight for the difference between the true value y and the estimated value y\hat{ }. Specifically, the time adjustment term (a/ΔT) can be incorporated as a coefficient of a difference between the true value y and the estimated value y\hat{ } and an argument of the hyperparameter δ. Any one of Expressions (4a) and (4b) may be used. The time adjustment term (a/ΔT) decreases as the time difference ΔT increases. Therefore, data with a larger time difference ΔT is considered less important in the loss calculation.

### (4) Cauchy Loss

FIG. 2B illustrates a Cauchy loss expression. The Cauchy loss is a robust loss function against outliers and thus is less affected by outliers as a characteristic. Expression (5) is a normal Cauchy loss expression, and Expression (5a) is an expression in which the time difference ΔT is incorporated as an argument of a function g(x). The time difference ΔT is incorporated as a weight for the difference between the true value y and the estimated value y\hat{ }. The function g(x) is expressed by Expression (5b). In Expression (5b), the time adjustment term (a/ΔT) is incorporated as a coefficient of a difference between the true value y and the estimated value y\hat{ }. The time adjustment term (a/ΔT) decreases as the time difference ΔT increases. Therefore, data with a larger time difference ΔT is considered less important in the loss calculation.

### (5) Welsch Loss

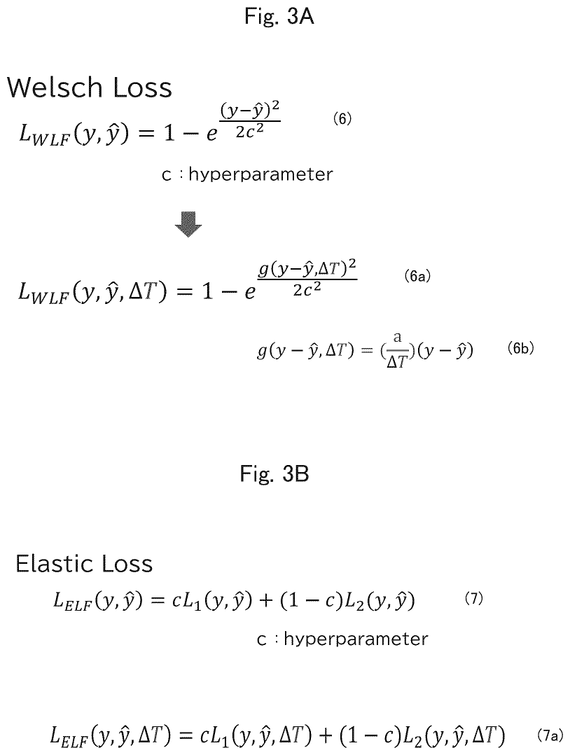

FIG. 3A illustrates a Welsch loss expression. The Welsch loss is also a robust loss function against outliers and suppresses the influence of outliers as a characteristic. Expression (6) is a normal Welsch loss expression, and Expression (6a) is an expression in which the time difference ΔT is incorporated as an argument of a function g(x). The time difference ΔT is incorporated as a weight for the difference between the true value y and the estimated value y\hat{ }. A function g(x) is expressed by Expression (6b). In Expression (6b), the time adjustment term (a/ΔT) is incorporated as a coefficient of a difference between the true value y and the estimated value y\hat{ }. The time adjustment term (a/ΔT) decreases as the time difference ΔT increases. Therefore, data with a larger time difference ΔT is considered less important in the loss calculation.

### (6) Elastic Loss

FIG. 3B illustrates an expression of the elastic loss. Elastic loss is also one of loss functions robust against outliers, and a difference between a true value and a prediction value is used. Expression (7) is a normal elastic loss expression, and Expression (7a) is an expression in which the time difference ΔT is incorporated as an argument of a loss L₁ and an argument of a loss L₂. The time difference ΔT is incorporated as a weight for the difference between the true value y and the estimated value y\hat{ }.

### (7) Quantile Loss

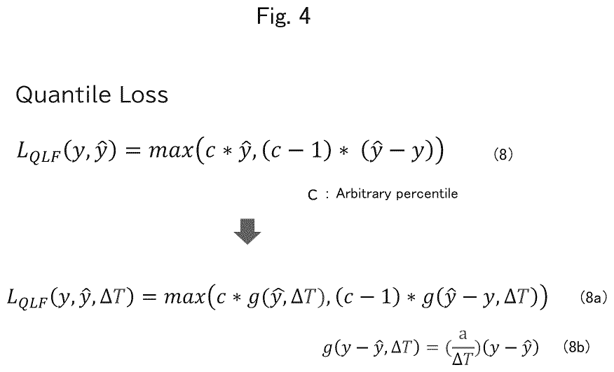

FIG. 4 illustrates an expression of the quantile loss. The quantile loss is used to minimize the prediction error for a specific quantile. Expression (8) is a normal quantile loss expression, and Expression (8a) is an expression in which the time difference ΔT is incorporated as an argument of a function g(x). The time difference ΔT is incorporated as a weight for the difference between the true value y and the estimated value y\hat{ }. The function g(x) is expressed by Expression (8b). In Expression (8b), the time adjustment term (a/ΔT) is incorporated as a coefficient of a difference between the true value y and the estimated value y\hat{ }. The time adjustment term (a/ΔT) decreases as the time difference ΔT increases. Therefore, data with a larger time difference ΔT is considered less important in the loss calculation.

### Overall Configuration

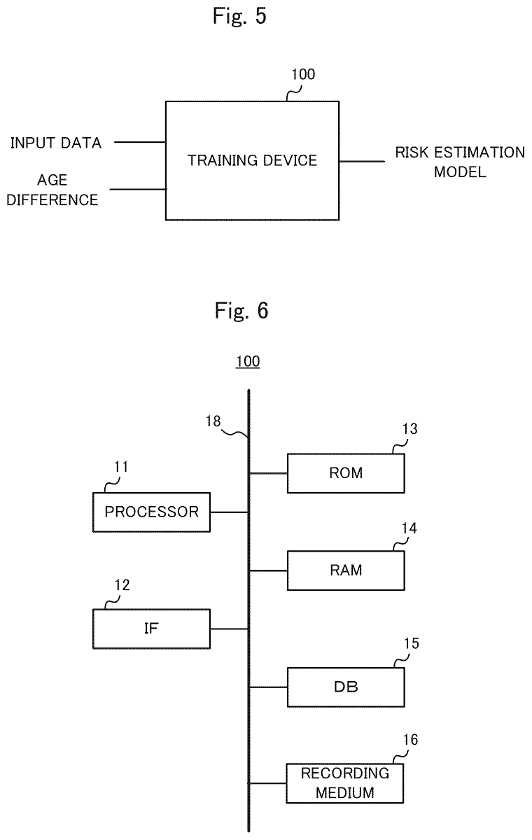

FIG. 5 illustrates an overall configuration of a training device according to a first example embodiment. A training device 100 trains a risk estimation model for estimating a disease risk to a subject, based on data regarding the health of the subject. Specifically, the data set of the training data used by the training device 100 includes input data, an age difference that is a time attribute of the input data, and a true value. The input data includes, for example, various pieces of data obtained by medical examination or the like, such as height, weight, sex, blood pressure, body mass index (BMI), body fat percentage, neutral fat value, smoking status and amount, drinking status and amount, and the like of the subject. Note that the input data may be multimodal data, namely, a plurality of pieces of data in the above-described various types of data. The age difference indicates a time difference from the current time of the input data. That is, the age difference is a difference between the current time point and the measurement time point of each input data. For example, in a case where data of three years ago is used as the training data, the age difference is “three years”.

The risk estimation model generated by the training device 100 can be favorably applied to the field of medicine or healthcare. For example, the risk estimation model can be used to estimate the risk of any lifestyle-related disease, based on data obtained in a regular medical examination.

### Hardware Configuration

FIG. 6 is a block diagram illustrating a hardware configuration of the training device 100. As illustrated, the training device 100 includes a processor 11, an interface (IF) 12, a read only memory (ROM) 13, a random access memory (RAM) 14, a database (DB) 15, and a storage medium 16. The components are connected through, for example, a bus 18.

The processor 11 corresponds to a computer, such as a central processing unit (CPU), and executes a program prepared in advance to control the entire training device 100. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

In addition, the processor 11 loads a program stored in the ROM 13 or the storage medium 16 into the RAM 14 and executes each process coded in the program. The processor 11 functions as part of the training device 100 or the entirety of the training device 100. Specifically, the processor 11 performs training processing, which will be described later.

The IF 12 performs transmission and reception of data to and from an external device. Specifically, the training device 100 receives, as training data, input data regarding the health of a plurality of persons through the IF 12. In addition, the training device 100 outputs a trained risk estimation model to a storage device or an external device through the IF 12.

The ROM 13 stores various programs executed by the processor 11. The RAM 14 is used as a working memory during the execution of various pieces of the processing by the processor 11.

The DB 15 stores various types of algorithms, data, and machine learning models for use when the training device 100 performs the training processing, which will be described later.

The storage medium 16 is a non-volatile, non-transitory storage medium, such as a disk-shaped recording medium and a semiconductor memory. The storage medium 16 may be detachably attached to the training device 100. The storage medium 16 records various programs to be executed by the processor 11.

Note that, in addition to the above, the training device 100 may include a display device, such as a liquid crystal display, and an input device, such as a keyboard or a mouse. Such a display device and an input device are used, for example, by an operator for the training device 100.

### Functional Configuration

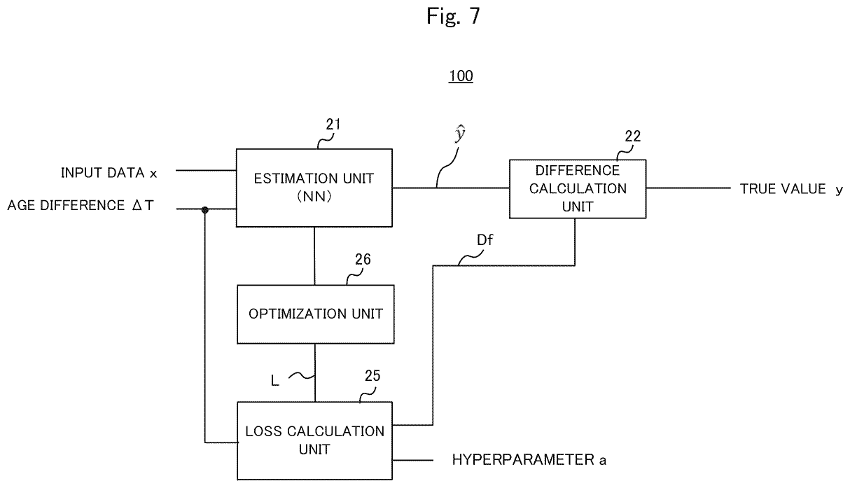

FIG. 7 is a block diagram illustrating a functional configuration of the training device 100. The training device 100 includes an estimation unit 21, a difference calculation unit 22, a loss calculation unit 25, and an optimization unit 26.

The estimation unit 21 includes a neural network (NN) that functions as a risk estimation model. Input data x included in a data set of training data is input to

The estimation unit 21. the input data x corresponds to an explanatory variable. in addition, an age difference ΔT between the current time point and the time point of the input data is input to the estimation unit 21. The estimation unit 21 estimates the risk from the input data x and the age difference ΔT by the risk estimation model, and outputs the estimated value y\hat{ } to the difference calculation unit 22. The difference calculation unit 22 calculates a difference Df between the estimated value y\hat{ } and a true value y and outputs the difference Df to the loss calculation unit 25. Note that the true value y corresponds to a response variable (objective variable) to an explanatory variable x.

The difference Df input from the difference calculation unit 22, the age difference ΔT, and a hyperparameter “a” of the loss function are input to the loss calculation unit 25. The loss calculation unit 25 calculates a loss L using the loss function incorporating the age difference ΔT, and outputs the loss L to the optimization unit 26. As the loss function in which the age difference ΔT is incorporated, it is possible to use a loss function indicated by the above-described Expressions (2b), (3b), (3c), (4a), (4b), (5a), (6a), (7a), or (8a).

The optimization unit 26 optimizes parameters of the neural network included in the estimation unit 21 in such a way that the loss L input from the loss calculation unit 25 is minimized. In this manner, the risk estimation model, which includes the neural network, is trained.

In the above configuration, the estimation unit 21 is an example of an acquisition means and an estimation means, the difference calculation unit 22 is an example of a difference calculation means, the loss calculation unit 25 is an example of a loss calculation means, and the optimization unit 26 is an example of a training means.

### Training Processing

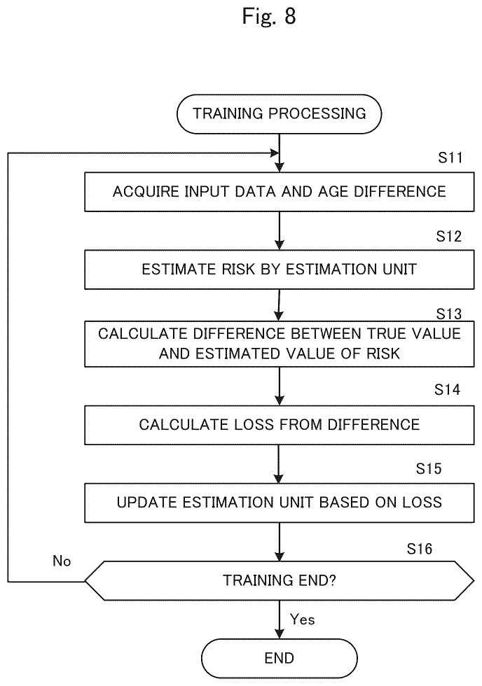

Next, the training processing that the above-described training device 100 performs will be described. FIG. 8 is a flowchart of the training processing. This processing is achieved by the processor 11 illustrated in FIG. 6 executing the programs prepared in advance and operating as the components illustrated in FIG. 7.

First, the estimation unit 21 acquires the input data included in the training data and the age difference (step S11). Next, the estimation unit 21 estimates a risk from the input data and the age difference using the risk estimation model including the neural network (step S12). Next, the difference calculation unit 22 calculates the difference between the true value and the estimated value of the risk (step S13).

Next, the loss calculation unit 25 calculates a loss from the difference by using a loss function in which the age difference ΔT is incorporated (step S14). Next, the optimization unit 26 updates the parameters of the neural network of the estimation unit 21 in such a way that the loss is reduced (step S15).

Next, the training device 100 determines whether a predetermined training end condition is satisfied (step S16). Examples of the training end condition include a condition that a predetermined number of pieces of data prepared as the training data have been used, a condition that the loss L is equal to or less than a predetermined value, and a condition that the loss L has converged. In a case where the training end condition is not satisfied (step S16: No), the processing returns to step S11. On the other hand, in a case where the training end condition is satisfied (step S16: Yes), the training processing ends.

### SECOND EXAMPLE EMBODIMENT

### Loss Function

In the second example embodiment, a loss function (hereinafter, it is also referred to as a “distribution consideration loss”) considering a probability distribution of training data is used. The existing loss functions aim to reduce the sum total of the differences between true values and estimated values in the entire distribution of training data. Thus, like the medical examination data of unhealthy persons, a small number of pieces of data deviating largely from the center of a distribution have a low contribution ratio to the sum total of losses in the entire distribution and thus tend to be neglected or ignored in training of an estimation model. On the other hand, the distribution consideration loss described below is a loss function adaptive to the distribution of the training data by weighting the loss using the distribution characteristic of the training data.

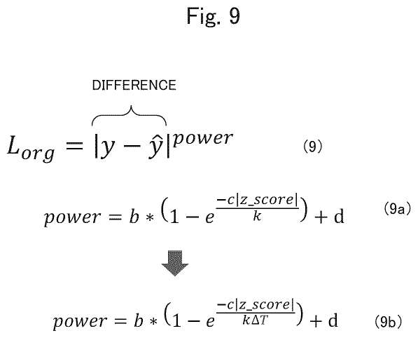

FIG. 9 illustrates an expression of a distribution consideration loss. The distribution consideration loss L_{org} of Expression (9) uses a Minkowski distance and includes a difference and an exponent that powers the difference. The exponent of the Minkowski distance is called a “power”. This power corresponds to a weight in the distribution consideration loss. The power indicates a deviation (degree of deviation) from the center of a probability distribution of training data, and is defined by an mean μ and a standard deviation σ as parameters of a probability density function indicating a normal distribution. The power can be expressed by Expression (9a) using a distance z_score from the center of the probability distribution of training data. The distance z_score is calculated from the mean μ and the standard deviation σ. Note that b, c, and d are hyperparameters.

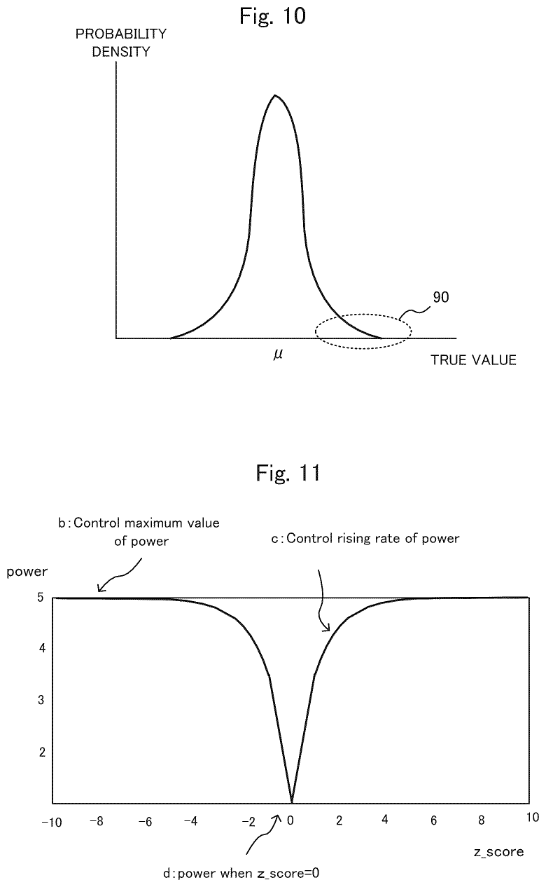

FIG. 10 illustrates an exemplary probability distribution of training data. Data of unhealthy persons in medical examination data gathers in a region 90 deviating from the center of the distribution (hereinafter, also referred to as an “outlier region”). In the outlier region 90, the distance from the center of the distribution is large and thus the value of the distance z_score is large. Thus, regarding the data in the outlier region 90, the value of the power expressed by Expression (9a), namely, the weight is large and thus the loss L_{org} is large. Thus, the influence of the data in the outlier region on the loss L_{org} can be increased. In Expression (9a), a probability distribution of training data is not necessarily accurately a normal distribution. Therefore, a skewness k is taken into account, depending on a probability distribution of training data to be used.

FIG. 11 is an explanatory graph for the hyperparameters b, c, and d in Expression (9a). In FIG. 11, the horizontal axis represents the distance z_score from the center of the probability distribution and the vertical axis represents the power. The hyperparameter b controls the maximum value of the power. The hyperparameter c controls the rising rate of the power. The hyperparameter d indicates the power in a case where the distance z_score is 0, namely, a starting point for the power. The hyperparameters b, c, and d are basically set by a user.

Expression (9a) in FIG. 9 is an expression of a normal distribution consideration loss. On the other hand, Expression (9b) is a distribution consideration loss expression in a case where the time difference ΔT is incorporated. In the present example embodiment, Expression (9b) is used as the loss function.

### Functional Configuration

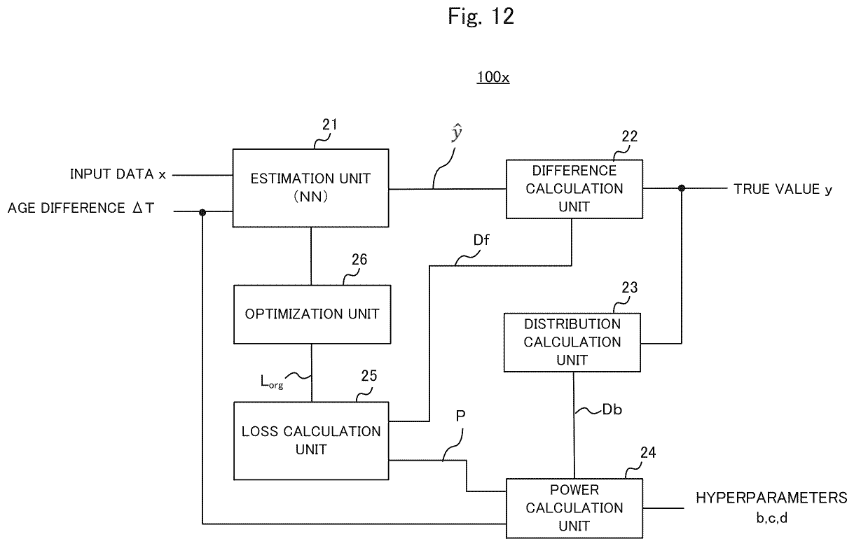

FIG. 12 is a block diagram illustrating a functional configuration of a training device 100x according to a second example embodiment. Note that the overall configuration of the training device 100x of the second example embodiment is the same as that in FIG. 5, and the hardware configuration is the same as that in FIG. 6. The training device 100x includes an estimation unit 21, a difference calculation unit 22, a distribution calculation unit 23, a power calculation unit 24, a loss calculation unit 25, and an optimization unit 26. Note that the estimation unit 21 and the difference calculation unit 22 are similar to those of the first example embodiment, and thus description thereof is omitted.

The distribution calculation unit 23 calculates a probability density function of the true value y of the training data to obtain a probability distribution. The distribution calculation unit 23 outputs, to the power calculation unit 24 and the loss calculation unit 25, a parameter Db that defines the obtained probability distribution. As an example, the parameter Db includes the mean μ and the standard deviation σ. The distribution calculation unit 23 is an example of a distribution calculation means.

The hyperparameters b, c, and d are set in the power calculation unit 24, and the age difference ΔT is input to the power calculation unit 24. The power calculation unit 24 obtains the distance z_score from the parameter Db, calculates a power P based on Expression (9b), and outputs the power P to the loss calculation unit 25.

Based on the difference Df input from the difference calculation unit 22 and the power P input from the power calculation unit 24, the loss calculation unit 25 calculates a loss L_{org} using the loss function expressed by Expression (9) and outputs the loss L_{org} to the optimization unit 26.

The optimization unit 26 optimizes the parameters of the neural network included in the estimation unit 21 in such a way that the loss L_{org} input from the loss calculation unit 25 is minimized. In this manner, the risk estimation model, which includes the neural network, is trained.

### Training Processing

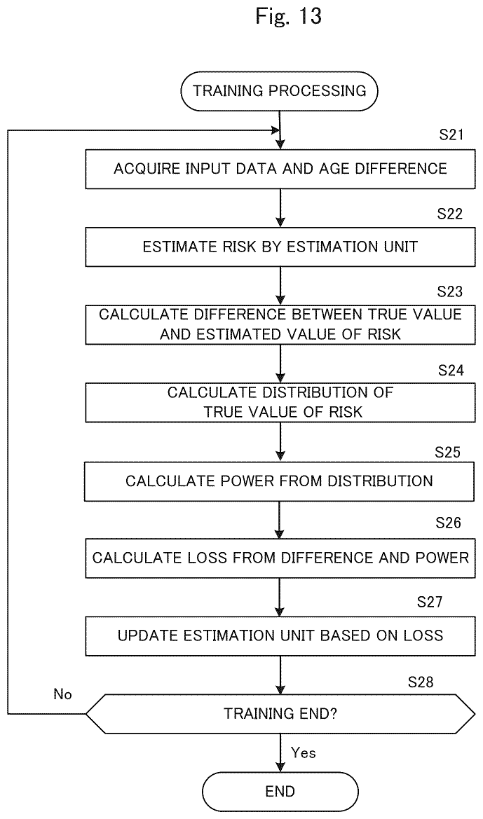

Next, the training processing executed by the above training device 100x will be described. FIG. 13 is a flowchart of the training processing. This processing is achieved by the processor 11 illustrated in FIG. 6 executing the programs prepared in advance and operating as the components illustrated in FIG. 12.

First, the estimation unit 21 acquires the input data included in the training data and the age difference ΔT (step S21). Next, the estimation unit 21 estimates a risk from the input data and the age difference ΔT using the risk estimation model including the neural network (step S22). Next, the difference calculation unit 22 calculates the difference between the true value and the estimated value of the risk (step S23). Next, the distribution calculation unit 23 calculates a probability distribution of the true values of the risk (step S24). Next, the power calculation unit 24 calculates power using the probability distribution of true values and the age difference ΔT (step S25).

Next, the loss calculation unit 25 calculates a loss from the difference and the power (step S26). Next, the optimization unit 26 updates the parameters of the neural network of the estimation unit 21 in such a way that the loss is reduced (step S27).

Next, the training device 100x determines whether a predetermined training end condition is satisfied (step S28). In a case where the training end condition is not satisfied (step S28: No), the processing returns to step S21. On the other hand, in a case where the training end condition is satisfied (step S28: Yes), the training processing ends.

### APPLICATION EXAMPLE

Next, application examples of the above-described example embodiment will be described below.

### First Application Example

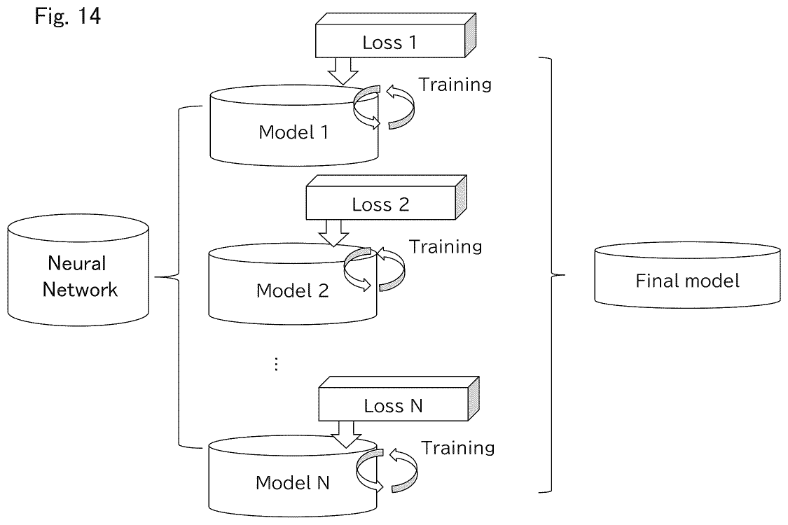

FIG. 14 illustrates an application example of the training device according to the example embodiment. A plurality of models is trained using a plurality of different loss functions described in the first and second example embodiments to generate a plurality of models having different characteristics. Then, a final model is generated by ensemble training using the generated plurality of models. Thus, a final model adaptive to various characteristics of input data can be constructed.

### Second Application Example

As described above, the loss functions of the present disclosure can be applied to training of a risk estimation model for estimating a disease risk based on medical examination data. As described above, the “difference in age” is added together with particular medical examination data (e.g., the blood glucose level) to the input data corresponding to the explanatory variable, enabling estimation of a disease risk in N years.

In addition, by setting the difference in age to 0 in the risk estimation model, it is possible to estimate another disease risk at the corresponding age of a subject. For example, in a case where a particular item of data is lacking in the medical examination data at a certain age of a certain subject, the particular item of data can be interpolated. In addition, based on the attribute of a subject, data of a virtual person similar in attribute to the subject can be generated. In addition, for a subject whose data at a certain age is missing, the missing data at the certain age can be generated using the data at the certain age of another subject.

For example, in a case where ten years of medical examination data of a plurality of persons is accumulated by collection in a continuous medical examination, the data is divided every two years to create groups G1 to G5 of data. Then, a difference is obtained based on any appropriate combination of the groups G1 to G5 of data, and medical examination data associated with a desired difference in age for the same person is created for use in training.

Furthermore, by classifying the groups G1 to G5 of data based on the age of a subject, medical examination data associated to each age group can be created. Thus, from ten years of data of persons in each age group, medical examination data in an age range of 10 years or more can be created in a pseudo-manner, and thus a risk estimation model capable of estimating a longer-term disease risk can be constructed.

### Third Example Embodiment

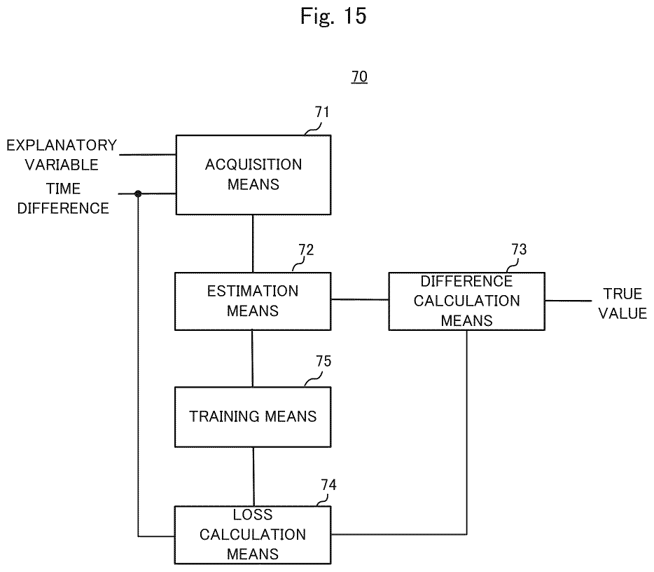

FIG. 15 is a block diagram illustrating a functional configuration of a training device according to a third example embodiment. A training device 70 includes an acquisition means 71, an estimation means 72, a difference calculation means 73, a loss calculation means 74, and a training means 75.

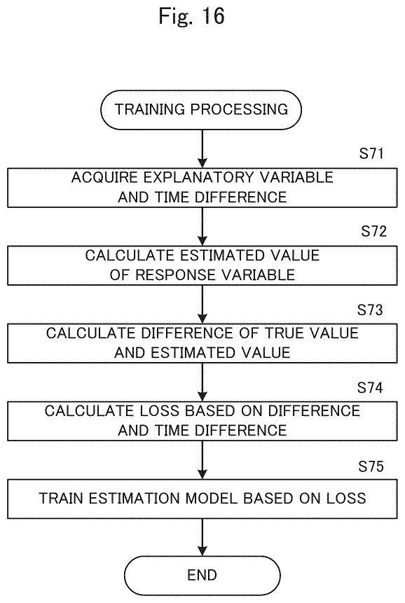

FIG. 16 is a flowchart of processing by the training device of the third example embodiment. The acquisition means 71 acquires the explanatory variable and the time difference between the acquisition time point of the true value of the response variable and the current time point (step S71). The estimation means 72 calculates an estimated value of the response variable from the explanatory variable using the estimation model (step S72). The difference calculation means 73 calculates the difference between a true value of the response variable and the estimated value (step S73). The loss calculation means 74 calculates a loss based on the difference and the time difference (step S74). The training means trains the estimation model based on the loss (step S75).

According to the training device 70 of the third example embodiment, it is possible to calculate a loss with an appropriate weight according to a time attribute of training data and train a model.

Some or all of the example embodiments described above may also be described as, but are not limited to, the following Supplementary notes.

### Supplementary Note 1

A training device comprising:
an acquisition means configured to acquire an explanatory variable and a time difference between an acquisition time point of a true value of a response variable and a current time point;
an estimation means configured to calculate an estimated value of a response variable from the explanatory variable by using an estimation model;
a difference calculation means configured to calculate a difference between the true value of the response variable and the estimated value;
a loss calculation means configured to calculate a loss based on the difference and the time difference; and
a training means configured to train the estimation model based on the loss.

### Supplementary Note 2

The training device according to Supplementary note 1, wherein the loss calculation means calculates the loss using the time difference as a weight for the difference.

### Supplementary Note 3

The training device according to Supplementary note 2, wherein the loss calculation means decreases the weight as the time difference increases.

### Supplementary Note 4

The training device according to Supplementary note 2, wherein the loss calculation means calculates the loss using a value obtained by multiplying a predetermined value by a reciprocal of the time difference as a coefficient or an exponent with respect to the difference.

### Supplementary Note 5

The training device according to Supplementary note 1, further comprising:
a distribution calculation means configured to calculate a probability density function from the true values of the response variable to obtain a probability distribution,
wherein the loss calculation means calculates the loss by assigning the difference with a weight based on the probability distribution.

### Supplementary Note 6

The training device according to Supplementary note 5, wherein the loss calculation means assigns a larger weight to a difference associated with the true value located farther from a center of the probability distribution.

### Supplementary Note 7

The training device according to Supplementary note 5, wherein the loss calculation means calculates a power in a Minkowski distance based on a parameter of the probability density function, and calculates the loss based on the difference and the power.

### Supplementary Note 8

The training device according to Supplementary note 1,
wherein the estimation model is a deep learning model, and
wherein the explanatory variable is data regarding health of a person, and the response variable is a disease risk to the person.

### Supplementary Note 9

A training method executed by a computer, comprising:
acquiring an explanatory variable and a time difference between an acquisition time point of a true value of a response variable and a current time point;
calculating an estimated value of a response variable from the explanatory variable by using an estimation model;
calculating a difference between the true value of the response variable and the estimated value;
calculating a loss based on the difference and the time difference; and
training the estimation model based on the loss.

### Supplementary Note 10

A program for causing a computer to perform processing comprising:
acquiring an explanatory variable and a time difference between an acquisition time point of a true value of a response variable and a current time point;
calculating an estimated value of a response variable from the explanatory variable by using an estimation model;
calculating a difference between the true value of the response variable and the estimated value;
calculating a loss based on the difference and the time difference; and
training the estimation model based on the loss.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

11 Processor
21 Estimation unit
22 Difference calculation unit
23 Distribution calculation unit
24 Power calculation unit
25 Loss calculation unit
26 Optimization unit
100, 100x Training device

1. A training device for machine learning comprising:
a memory configured to store instructions; and
one or more processors configured to execute the instructions to:
acquire, for each of a plurality of training samples, an explanatory variable and a true value of a response variable, and a time difference between an acquisition time point of the true value and a present time point;
calculate an estimated value of a response variable from the explanatory variable by using an estimation model that is a machine learning model;
calculate a difference between the true value of the response variable and the estimated value;
calculate a loss based on the difference and the time difference; and
update parameters of the estimation model and thereby train the estimation model based on the loss.

2. The training device according to claim 1, wherein the one or more processors calculate the loss using the time difference as a weight for the difference.

3. The training device according to claim 2, wherein the one or more processors decrease the weight as the time difference increases.

4. The training device according to claim 2, wherein the one or more processors calculate the loss using a value obtained by multiplying a predetermined value by a reciprocal of the time difference as a coefficient or an exponent with respect to the difference.

5. The training device according to claim 1,
wherein the one or more processors are further configured to execute instructions to calculate a probability density function from the true values of the response variable to obtain a probability distribution, and
wherein the one or more processors calculate the loss by assigning the difference with a weight based on the probability distribution.

6. The training device according to claim 5, wherein the one or more processors assign a larger weight to a difference associated with the true value located farther from a center of the probability distribution.

7. The training device according to claim 5, wherein the one or more processors calculate a power in a Minkowski distance based on a parameter of the probability density function, and calculate the loss based on the difference and the power.

8. The training device according to claim 7, wherein the parameter of the probability density function is a distance of the true value from a center of the probability distribution.

9. The training device according to claim 8, wherein one or more processors calculate the power using a first hyperparameter that controls a maximum value of the power.

10. The training device according to claim 8, wherein one or more processors calculate the power using a second hyperparameter that controls rising rate of the power.

11. The training device according to claim 8, wherein one or more processors calculate the power using a third hyperparameter that indicates the power in a case where the distance of the true value from the center of the probability distribution is 0.

12. The training device according to claim 7, wherein the power corresponds the weight in the distribution-considered loss.

13. The training device according to claim 1,
wherein the estimation model is a deep learning model, and
wherein the explanatory variable is data regarding health of a person, and the response variable is a disease risk to the person.

14. A training method for machine learning executed by a computer, comprising:
acquiring, for each of a plurality of training samples, an explanatory variable and a true value of a response variable, and a time difference between an acquisition time point of the true value and a present time point;
calculating an estimated value of a response variable from the explanatory variable by using an estimation model that is a machine learning model;
calculating a difference between the true value of the response variable and the estimated value;
calculating a loss based on the difference and the time difference; and
updating parameters of the estimation model and thereby training the estimation model based on the loss.

15. A non-transitory computer-readable recording medium storing a program, the program causing a computer to perform processing comprising:
acquiring, for each of a plurality of training samples, an explanatory variable and a true value of a response variable, and a time difference between an acquisition time point of the true value and a present time point;
calculating an estimated value of a response variable from the explanatory variable by using an estimation model that is a machine learning model;
calculating a difference between the true value of the response variable and the estimated value;
calculating a loss based on the difference and the time difference; and
updating parameters of the estimation model and thereby training the estimation model based on the loss.
